(19) United States
(12) Patent Application Publication
(10) Pub. No.: US 2013/0051037 A1
(43) Pub. Date: Feb. 28, 2013

(54) LIGHT STANDARD BARRIER DEVICE

(71) Applicant: JOSEPH ROY LaFORGE, ST. Thomas (CA)

(72) Inventor: JOSEPH ROY LaFORGE, ST. Thomas (CA)

(21) Appl. No.: 13/215,353

(22) Filed: Aug. 23, 2011

(51) Int. Cl. F21V 17/00

(52) U.S. Cl. 362/375

(57) ABSTRACT

An aperture barrier for a standardized light standard having a walled aperture having a first or second standardized dimension at the rear thereof in communication with a wire bearing conduit. The aperture barrier has a body portion having a standardized first outer dimension and a thickness. The aperture barrier further has a removable inner body portion releasably secured in the body portion having a second standardized outer dimension and a thickness.

### FIELD OF THE INVENTION

The invention relates to a bird and/or small animal barrier for a roadway light standard.

### BACKGROUND OF THE INVENTION

A common problem with roadway light standards or luminaires is the tendency of birds, squirrels and other small animals to nest or otherwise enter inside the headcasing. The point of entry into the headcasing is through the pre-existing aperture between the headcasing and the headpole. Squirrels may eat the insulation coating on the wires, birds may be electrocuted, and birds' nests may catch fire. These problems require additional maintenance to be performed and parts replacement which is costly. Even worse, nest fires may necessitate the dispatch of fire, police and service crews to deal with the resultant luminaire fire.

One approach to dealing with these problems involves the installation of a barrier device internally to the light standard such that it forms an integral part of the light standard, as disclosed in “Luminaire Shield Device” (U.S. Pat. No. 4,010,362) and “Fauna Guard” (U.S. Pat. No. 4,320,443). However, a drawback to this approach is that the installation of the barrier requires the disassembly of the luminaire, or in some cases, the removal of the luminaire from the headpole altogether. In practice, this labour requirement often results in maintenance workers choosing not to install the device at all, which omission cannot be ascertained by visual inspection of the luminaire from the ground.

A further drawback is the lack of adaptability of these barrier devices to be used with light standards with variously sized apertures. Generally light standards are manufactured with an aperture of one of a few standardized sizes which necessitates the ordering and use of multiple devices to fit the variously sized aperture holes.

Another approach has been to install a barrier device externally to the light standard, as disclosed in “Luminaire Birdshield” (U.S. Pat. No. 4,434,456) and “Streetlight Light Lifetime Saver/Anti-Pollution Device” (CA Application 2,087,640), such that it may be fitted and replaced without the need to disassemble the luminaire or remove it from the headpole. Drawbacks to these devices include the physical manipulation required to install them which cannot be effectively accomplished while wearing protective gloves. As well, exposure to the elements and/or animal pecking and clawing activity, may dislodge these devices.

There is, accordingly, a need for improvements to barrier devices that overcome the above problems.

### SUMMARY OF THE INVENTION

One object of the present invention is to provide an aperture barrier for a standardized light standard having a walled aperture having a first or second standardized dimension at the rear thereof in communication with a wire bearing conduit. The aperture barrier has a body portion having a standardized first outer dimension and a thickness. The aperture barrier further has a removable inner body portion releasably secured in the body portion having a second standardized outer dimension and a thickness. The body portion is dimensioned to frictionally engage with the wall of the aperture of the first standardized dimension upon insertion therein, and the inner body portion is dimensioned to frictionally engage with the walls of the aperture of the second standardized dimension upon insertion therein. Additionally, the body portion and the inner body portion further have openings for the passage of wires from the conduit into the light standard.

A further object of the present invention is to provided at least one grasping tab on at least one of the body portion or the inner body portion for grasping during installation or removal of the barrier

Another objection of the invention is to provide tabs on the outer periphery of the body portion to frictionally engage with the walls of the aperture of the first standardized dimension upon insertion therein.

A further objection of the present invention is to provide ribs on the outer periphery of the inner body portion to frictionally engage with the walls of the aperture of the second standardized dimension upon insertion therein.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a perspective view of the barrier.

FIG. 2a is a front view of the barrier.

FIG. 2b is a rear view of the barrier.

FIG. 3 is a side view of the barrier.

### DESCRIPTION OF PREFERRED EMBODIMENTS

A barrier 20 according to the present invention is illustrated in the figures. The barrier 20 is moulded from a resilient yet flexible type of rubber such as, by way of example, “DSM Sarlink 4180”, that remains pliable in sub-zero weather and will not degrade or break down in higher temperatures.

An opening or aperture at the rear of the light standard, herein called the headcasing aperture, remains open after the headpole pipe is installed to the headcasing. The barrier 20, according to the present invention, may be installed after the assembly of the light standard to close the headcasing aperture.

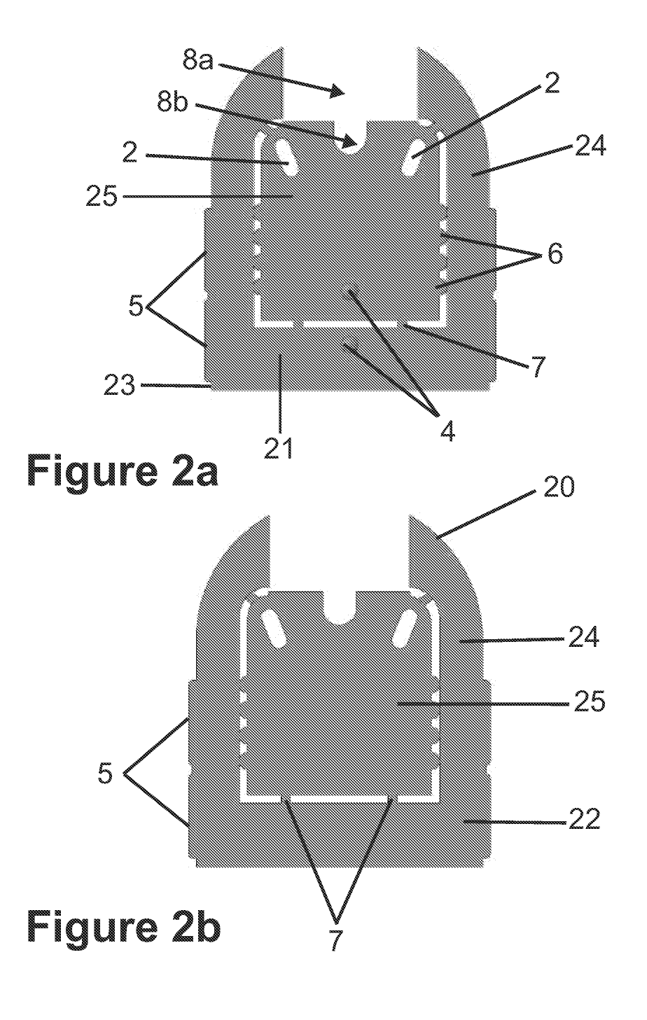

In the preferred embodiment the barrier 20 may have substantially planar opposing faces, a front face 21 and a rear face 22, separated by a thickness that is substantially less that the length and width of opposing faces. As shown in FIG. 2a, the barrier 20 according to the present invention is generally comprised of two components, a body portion 24 and a removable inner body portion 25. The body portion 24 houses the inner body portion 25 within which it is releasable secured by way of releasable connecting means 7. The connecting means 7 may be of any type known in the art which permit easy manual removal by the installer of the barrier to separate the inner body portion 25 from the main body portion 24. In the preferred embodiment, as illustrated in FIGS. 2a and 2b, the connecting means are regularly or irregularly spaced perforations along the outer perimeter of the inner body portion 25. As will be described hereafter, the ribs 6 also function as connecting means.

In the preferred embodiment of the present invention the barrier 20 can be adapted for use on light standards with headcasing apertures of two different standardized sizes. The barrier 20 can be used to fill larger headcasing apertures with the inner body portion 25 remaining attached to and within the body portion 24. Alternatively, the inner body portion 25 may be separated from the body portion 24 and used independently to fill a smaller standardized headcasing aperture. The dimension and shape of the body portion 24 and the inner body portion 25 may be varied for use on light standards with varying sized headcasing apertures.

In the preferred embodiment the body portion 24 is dimensioned to close the headcasing aperture in a light standard with a 2″ headpole when inserted into the headcasing aperture. The inner body portion 25 is dimensioned to close the headcasing aperture in a light standard with a 1¼″ headpole when detached from the body portion 24 and inserted into the headcasing aperture.

As shown in FIG. 2, the barrier 20 is moulded with openings 8a and 8b which are dimensioned to allow space for the operative cables/wires to pass through between the conduit and the light standard when the barrier 20 is installed in the headcasing aperture. The size and shape of the openings 8a and 8b may be any small suitable size to accommodate the wiring.

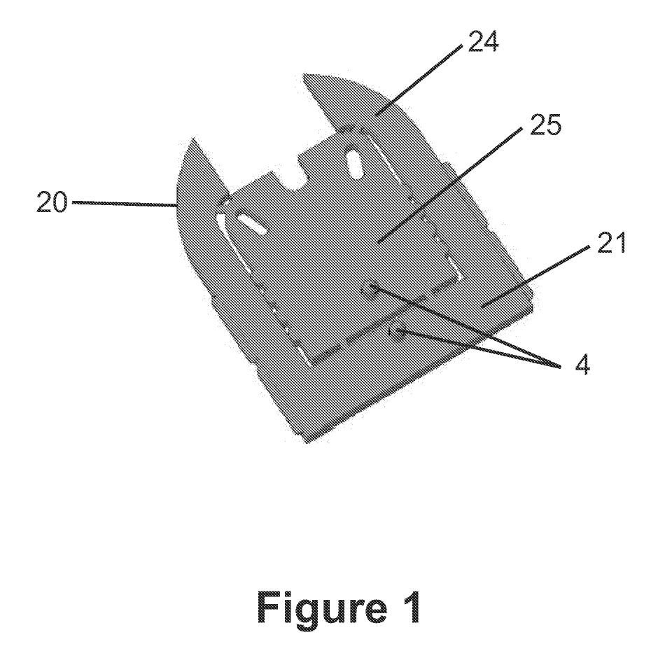

As shown in FIG. 1, the barrier 20 may be provided with ventilation holes 2 to allow for air circulation within the headcasing. Additionally, the ventilation holes 2 aid in the dissipation of the heat generated from the light bulb in the head casing. The ventilation holes 2 may be provided in either the outer body 24 or the inner body portion 25 of the barrier 20. In the preferred embodiment, as illustrated in the figures, the ventilation holes 2 are provided in the inner body portion 25.

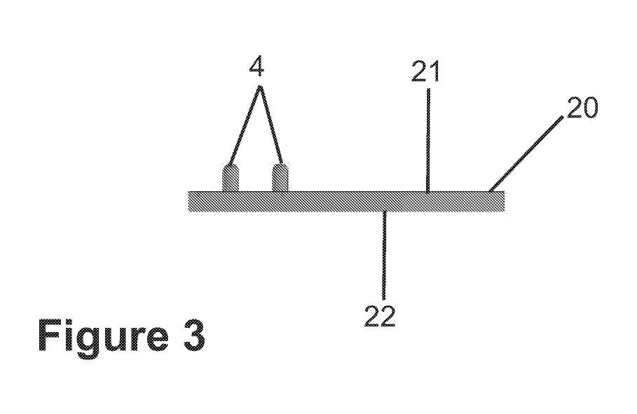

As shown in FIGS. 1, 3a, and 3b, plier grasping tabs 4 may be provided on the front face 21 of both the inner body portion 25 and the body portion 24. In the preferred embodiment the grasping tabs 4 are moulded integral with the barrier 20. However, the grasping tabs 4 may be formed of a different material from the barrier 20 and attached thereto using means known in the art. The grasping tabs 4 can be grasped and manipulated by the installer to facilitate the installation or removal of the barrier 20 from the light standard opening 8. In the preferred embodiment illustrated in the FIG. 2a a grasping tab 4 is provided on both the inner body portion 25 and the outer portion of the barrier 20.

Outwardly protruding tabs 5 may be provided on the exterior edge 23 of the outer portion of the barrier 20. During the installation of the barrier 20 the tabs 5 aid in the frictional engagement of the barrier 20 with the wall of the headcasing aperture. In the preferred embodiment the tabs 5 may be moulded integral with the outer portion of the barrier 20.

Outwardly protruding ribs 6 may be provided along the outer perimeter of the inner body portion 25. During the installation of the inner body portion 25 into the headcasing aperture the ribs 6 may be forced into an abutting relationship with the interior wall of the headcasing aperture to aid in the frictional engagement of the barrier 20 with the headcasing. In the preferred embodiment the ribs 5 may be moulded integral with the inner body portion 25 of the barrier 20 and are connected to the body portion 24 at their extremity. The connection between the ribs 6 and the body portion 24 may be correspondingly thinned so as to function as releasable connection means 7 to accommodate the removal of the inner body portion 25 from the body portion 24.

As shown in FIG. 3, the barrier 20 is moulded with a constant thickness. In an alternative embodiment the exterior edge 23 may be bevelled to further accommodate the installation of the barrier 20. During installation, the barrier 20 is positioned such that the rear face 22 of the barrier 20 is aligned with the headcasing aperture and the wires or cables are collected and placed in the opening 8, whereby front face 21 and grasping tabs 4 face outward from the headcasing aperture. The installer then applies pressure to front face 21 of the barrier 20 to force the rear face 22 of the barrier 20 to enter the headcasing aperture. As the rear face 22 of the barrier 20 enters the headcasing aperture the bottom exterior edge 23 of the barrier 20 will be brought into contact and frictional engagement with the wall of the headcasing aperture to thereby secure the barrier 20 in place.

In an alternative embodiment of the present invention the exterior edge 23 of the barrier 20 may be angled inwardly such that the front face 21 of the barrier 20 is larger than the rear face 22 of the barrier 20. The dimensions of the front face 21 may be slightly larger than the dimensions of the headcasing aperture and the dimensions of the rear face 22 may be slightly smaller than the dimensions of the head aperture. During installation, the barrier 20 is positioned such that the rear face 22 of the barrier 20 is aligned with the headcasing aperture and the wires or cables are collected and placed over the opening 8. The installer then applies pressure to front face 21 of the barrier 20 forcing the rear face 22 of the barrier 20 to enter the headcasing aperture. As the rear face 22 of the barrier 20 enters the headcasing aperture the exterior edge 23 of the barrier 20 will be brought into contact and frictional engagement with the wall of the headcasing aperture.

Further advantages which are inherent to the invention are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed is:

1. An aperture barrier for a standardized light standard having a walled aperture having a first or second standardized dimension at the rear thereof in communication with a wire bearing conduit, the aperture barrier comprising:
a body portion having a standardized first outer dimension and a thickness; and
a removable inner body portion releasably secured in the body portion having a second standardized outer dimension and a thickness, wherein the body portion is dimensioned to frictionally engage with the wall of the aperture of the first standardized dimension upon insertion therein, wherein the inner body portion is dimensioned to frictionally engage with the walls of the aperture of the second standardized dimension upon insertion therein, and wherein the body portion and the inner body portion further comprise an opening for the passage of wires from the conduit into the light standard.

2. A barrier as defined in claim 1, wherein the body portion further comprises at least one grasping tab.

3. A barrier as defined in claim 1, wherein the inner body portion further comprises at least one grasping tab.

4. A barrier as defined in claim 1, wherein the inner body portion further comprises at least one hole for air passage.

7. A barrier as defined in claim 1, wherein the barrier is moulded from resilient flexible material.

8. A barrier as defined in claim 7, wherein the barrier is moulded from DSM Sarlink 4180 material.

10. A barrier as defined in claim 1, wherein the body portion further comprises tabs on the outer periphery thereof to frictionally engage with the walls of the aperture of the first standardized dimension upon insertion therein.

11. A barrier as defined in claim 1, wherein the inner body portion further comprises ribs on the outer periphery thereof to frictionally engage with the walls of the aperture of the second standardized dimension upon insertion therein.
